(19) United States
(12) Patent Application Publication
(10) Pub. No.: US 2026/0326785 A1
(43) Pub. Date: Oct. 22, 2026

(54) SYSTEM AND METHOD FOR OPTIMIZING PERFORMANCE OF AN AUTONOMOUS VEHICLE USING A PLURALITY OF CONTROLLERS

(71) Applicants: Constructor Technology AG, Schaffhausen (CH); Constructor Education and Research Genossenschaft, Schaffhausen (CH)

(72) Inventors: Maksim FILIPENKO, Batumi (GE); Aleksandr BUIVAL, Bremen (DE); Ruslan MUSTAFIN, Tbilisi (GE); Ilya SHIMCHIK, Zurich (CH); Stanislav Protasov, Singapore (SG); Serg Bell, Singapore (SG); Nikolay Dobrovolskiy, Alanya (TR)

(21) Appl. No.: 19/185,354

(22) Filed: Apr. 22, 2025

Related U.S. Application Data
(63) Continuation-in-part of application No. 19/086,217, filed on Mar. 21, 2025.
Application No. 19/086,217 is a continuation of application No. 18/045,158, filed on Oct. 9, 2022, now Pat. No. 12,275,393.

(51) Int. Cl. B60W 60/00

(52) U.S. Cl. CPC B60W 60/001

(57) ABSTRACT

A system collects a first plurality of real-time parameter values associated with an autonomous vehicle driving in a race track. The system generates, by a first controller of a plurality of controllers, at least one command for driving the autonomous vehicle based on the first plurality of real-time parameter values. In response to determining that an amount of time spent driving in a segment of the race track exceeds a threshold amount of time when the autonomous vehicle executes the at least one command, the system selects a second controller of the plurality of controllers to generate further commands for driving the autonomous vehicle. The system collects a second plurality of real-time parameter values, and generates, by the second controller of the plurality of controllers, at least one additional command for driving the autonomous vehicle based on the second plurality of real-time parameter values.

### CROSS-REFERENCE TO RELATED APPLICATIONS

This application is a continuation-in-part of U.S. Non-Provisional application Ser. No. 19/086,217, filed Mar. 21, 2025, which further is a continuation of U.S. Non-Provisional application Ser. No. 18/045,158, filed Oct. 9, 2022, which is herein incorporated by reference.

### TECHNICAL FIELD

The present subject matter is related to autonomous vehicles. In particular, the present subject matter relates to a system and method for optimizing the performance of an autonomous vehicle to reduce lap times. More specifically, the present subject matter envisages the variation of one or more parameters of the autonomous vehicle as well as that of the racetrack, on which the autonomous vehicle is driving, in real-time for improving the lap time of the autonomous vehicle.

### BACKGROUND

Autonomous vehicles are enabled with self-driving capabilities by employing vehicular automation. More specifically, an autonomous vehicle is specifically designed to sense the environment and operate with little or no human intervention. Autonomous or self-driving racing is an upcoming and evolving sport of racing autonomous vehicles. In autonomous racing sports competitions, one of the most important things is to achieve the fastest lap time. A challenge, however, is posed due to the absence of a human driver. More specifically, the absence of the human driver directly translates to the absence of driving expertise that allows the human driver to make efficient and quick decisions to change the driving technique for achieving the fastest lap time. Such changes may be influenced by many parameters, such as, for example, tire wear, condition of the circuit road surface, temperature, humidity, rainfall, and so on.

For autonomous vehicles, an important requirement is to overcome the disadvantageous aspect of the absence of a human driver. More specifically, for improving the lap times for consecutive laps of a racing circuit during a race, the autonomous vehicle is required to optimize its performance in real-time for ensuring improvement in lap times for consecutive laps.

There is a need for systems and methods for autonomous vehicles for monitoring different parameters that influence the driving decisions that would be made by a human driver in traditional racing.

### SUMMARY

The described systems and methods focus on improving how an autonomous vehicle performs on a race track in real-time. Initially, the vehicle collects data about its current driving conditions. A first controller uses this data to issue driving commands. If the vehicle takes too long in a specific track segment, a second controller takes over to provide new commands. This second controller may be the same as the first but with different settings, or an entirely new type of controller. The system can use various types of controllers, such as a Proportional-Integral-Derivative (PID) controller, a Linear Quadratic Regulator (LQR) controller, a Model Predictive Control (MPC) controller, a Model Predictive Path Integral (MPPI) controller, and/or a Reinforcement Learning (RL) controller, to optimize the vehicle's performance.

In an exemplary aspect, the techniques described herein relate to a method for optimizing a performance of an autonomous vehicle in real-time, the method including: collecting a first plurality of real-time parameter values associated with an autonomous vehicle driving in a race track; generating, by a first controller of a plurality of controllers, at least one command for driving the autonomous vehicle based on the first plurality of real-time parameter values; in response to determining that an amount of time spent driving in a segment of the race track exceeds a threshold amount of time when the autonomous vehicle executes the at least one command, selecting a second controller of the plurality of controllers to generate further commands for driving the autonomous vehicle; collecting a second plurality of real-time parameter values associated with the autonomous vehicle driving in the race track; and generating, by the second controller of the plurality of controllers, at least one additional command for driving the autonomous vehicle based on the second plurality of real-time parameter values.

In some aspects, the techniques described herein relate to a method, wherein the second controller is the first controller with a different set of configurations.

In some aspects, the techniques described herein relate to a method, wherein the plurality of controllers includes any combination of: a PID controller, an LQR controller, an MPC controller, an MPPI controller, and an RL controller.

In some aspects, the techniques described herein relate to a method, wherein selecting the second controller is performed by a controller manager that accesses a list indicative of the plurality of controllers and various configurations of each of the plurality of controllers.

In some aspects, the techniques described herein relate to a method, wherein selecting the second controller of the plurality of controllers includes: determining a priority value of the second controller; determining at least one other priority value of other controllers in the plurality of controllers; in response to determining that the priority value exceeds the at least one other priority value, selecting the second controller.

In some aspects, the techniques described herein relate to a method, wherein the priority value is determined based on at least one of: previous drives performed on the race track, drives performed in at least one simulation on a virtual representation of the race track, a current drive of the autonomous vehicle on a previous segment of the race track.

In some aspects, the techniques described herein relate to a method, wherein a higher priority value is assigned to a given controller of the plurality of controllers in response to determining that the given controller generates commands causing a lowest amount of time spent driving in a segment of the race track.

In some aspects, the techniques described herein relate to a method, further including: identifying instability of the autonomous vehicle in response to detecting one or more discrepancies between the at least one command generated by the first controller and an execution of the at least one command by the autonomous vehicle; generating, by the first controller, a corrective action for resolving the instability; in response to determining that the corrective action does not resolve the instability, selecting the second controller of the plurality of controllers to generate further corrective actions for driving the autonomous vehicle.

In some aspects, the techniques described herein relate to a method, wherein the segment is a lap around the race track.

In some aspects, the techniques described herein relate to a system for optimizing a performance of an autonomous vehicle in real-time, including: at least one memory; and at least one hardware processor coupled with the at least one memory and configured, individually or in combination, to: collect a first plurality of real-time parameter values associated with an autonomous vehicle driving in a race track; generate, by a first controller of a plurality of controllers, at least one command for driving the autonomous vehicle based on the first plurality of real-time parameter values; in response to determining that an amount of time spent driving in a segment of the race track exceeds a threshold amount of time when the autonomous vehicle executes the at least one command, select a second controller of the plurality of controllers to generate further commands for driving the autonomous vehicle; collect a second plurality of real-time parameter values associated with the autonomous vehicle driving in the race track; and generate, by the second controller of the plurality of controllers, at least one additional command for driving the autonomous vehicle based on the second plurality of real-time parameter values.

In some aspects, the techniques described herein relate to a non-transitory computer readable medium storing thereon computer executable instructions for optimizing a performance of an autonomous vehicle in real-time, including instructions for: collecting a first plurality of real-time parameter values associated with an autonomous vehicle driving in a race track; generating, by a first controller of a plurality of controllers, at least one command for driving the autonomous vehicle based on the first plurality of real-time parameter values; in response to determining that an amount of time spent driving in a segment of the race track exceeds a threshold amount of time when the autonomous vehicle executes the at least one command, selecting a second controller of the plurality of controllers to generate further commands for driving the autonomous vehicle; collecting a second plurality of real-time parameter values associated with the autonomous vehicle driving in the race track; and generating, by the second controller of the plurality of controllers, at least one additional command for driving the autonomous vehicle based on the second plurality of real-time parameter values.

### BRIEF DESCRIPTION OF DRAWINGS

FIG. 1 illustrates a schematic block diagram of a system for optimizing the performance of an autonomous vehicle to reduce the lap times during a race event.

FIG. 2 illustrates a schematic block diagram depicting a general operational scheme of the system.

FIG. 3 illustrates a detailed block diagram of the system for optimizing the performance of an autonomous vehicle to reduce the lap times during a race event using different controllers.

FIG. 4 illustrates a schematic block diagram of a method for optimizing the performance of an autonomous vehicle to reduce the lap times during a race event.

FIG. 5 illustrates a schematic block diagram depicting a general operational scheme of the method.

FIG. 6 illustrates a flow diagram of a method for optimizing the performance of an autonomous vehicle to reduce the lap times during a race event using different controllers.

FIG. 7 presents an example of a general-purpose computer system on which aspects of the present disclosure can be implemented.

### DETAILED DESCRIPTION

The embodiments will now be described more fully hereinafter with reference to the accompanying figures, in which alternative embodiments are shown.

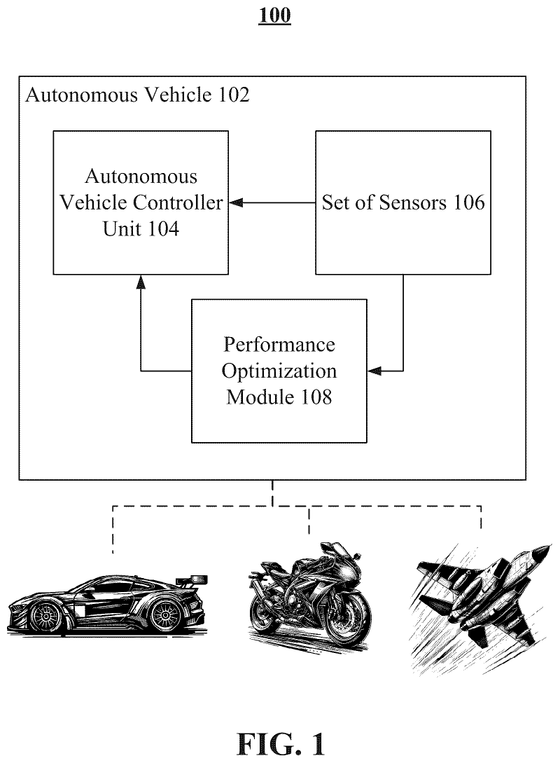

FIG. 1 illustrates a schematic block diagram of a system 100 for optimizing the performance of an autonomous vehicle 102 to reduce the lap times during a race event (hereinafter referred to as system 100), in accordance with an embodiment of the present subject matter. The system 100, in accordance with an embodiment of the present subject matter, comprises an autonomous vehicle controller unit 104 pre-fed with the first set of initial parameter values and the second set of initial parameter values.

In accordance with an embodiment of the present subject matter, the first set of initial parameter values includes a plurality of parameter values associated with the autonomous vehicle before the start of the race event. Some examples of the first set of initial parameter values include the values of battery charge, motor condition, tire wear, tire temperature, tire pressure, motor temperature, and so on. As a general consideration, the first set of initial parameter values may be all those parameter values that are associated with the autonomous vehicle just before the starting of a race event. Therefore, the first set of initial parameter values may be base reference parameter values for all the different parameters of the autonomous vehicle just before the starting of the race event. Thus, the first set of initial parameter values may indicate the different parameter values of the autonomous vehicle 102 when the autonomous vehicle 102 is primed and in its best condition for the race event.

In accordance with an embodiment of the present subject matter, the second set of initial parameter values includes a plurality of parameter values associated with the environment and the race circuit road surface before the starting of the race event. Therefore, the second set of initial parameter values may include, for example, a map layout. This may include data associated with the race circuit such as road inclination, curb positions, uphill and downhill sections, and so on. Other values include information associated with weather conditions just before the race event, information associated with a race-circuit road surface, and so on. In other words, the second set of initial parameter values may include information associated with all those parameters that are external to the autonomous vehicle 102 but may still affect the performance of the autonomous vehicle 102 during the race event.

The system 100 further comprises a set of sensors 106 communicatively coupled to the autonomous vehicle controller unit 104. The set of sensors 106 is configured for measuring a first set of real-time parameter values and the second set of real-time parameter values subsequent to the starting of the race event. In one embodiment, the set of sensors 106 may include lidars, cameras, IMU, real-time kinematic positioning (GNSS-RTK), temperature sensors, pressure sensors, slip angle sensors, operational support system (OSS), radars, wheel encoder, body slip angle, tire slip angle, and so on. Therefore, the set of sensors 106 includes all the sensors that are configured onboard the autonomous vehicle 102 and are provided for measuring parameters that may affect the performance of the autonomous vehicle 102 during the race event.

In accordance with an embodiment of the present subject matter, the first set of real-time parameter values includes a plurality of parameter values associated with the autonomous vehicle subsequent to the starting of the race event. Some examples of the first set of real-time parameter values include the values of battery charge, motor condition, tire wear, tire temperature, tire pressure, motor temperature, and so on that are taken at predetermined time intervals subsequent to the starting of the race event. As a general consideration, the first set of real-time parameter values may be all those parameter values that are associated with the autonomous vehicle that is taken in real-time after the starting of the race event. An advantageous aspect of monitoring the different parameter values of the autonomous vehicle 102 in real-time is that these parameter values may be used for the purpose of improving the performance of the autonomous vehicle 102 in real-time during the race event.

In accordance with an embodiment of the present subject matter, the second set of real-time parameter values includes a plurality of parameter values associated with the environment and the race circuit road surface after the start of the race event. Therefore, the second set of real-time parameter values may include, for example, a map layout of a race circuit for the race event, information associated with weather conditions just before the race event, information associated with the race circuit road surface at different locations along the race circuit such as wet patches, patches with excessive debris and tire dust, turn sharpness, and so on. Thus, the second set of real-time parameter values may include information associated with all those parameters that are external to the autonomous vehicle 102 but may still affect the performance of the autonomous vehicle 102 during the race event.

The system 100 further comprises a performance optimization module 108 configured onboard the autonomous vehicle 102. The performance optimization module 108 is configured for receiving the first set of real-time parameter values and the second set of real-time parameter values. More specifically, the performance optimization module 108 includes the optimization algorithm for receiving, analyzing, and extracting meaningful deductions from the received values of the first set of real-time parameter values and the second set of real-time parameter values. In an exemplary embodiment, the optimization algorithm is a machine-learning algorithm. The performance optimization module 108 is further configured for detecting the presence of one or more errors between a control command given by the autonomous vehicle controller unit 104 to the autonomous vehicle 102 and the execution of the control command by the autonomous vehicle 102 to determine vehicle instability, wherein the detection is based on the first set of real-time parameter values and the second set of real-time parameter values.

In accordance with one embodiment of the present subject matter, the performance optimization module 108 is configured for learning additional information associated with the autonomous vehicle 102, the race circuit road surface, and the environment based on the detection. Furthermore, if the performance optimization module 108 detects that there is, in fact, an error between the control command executed by the autonomous vehicle controller unit 104 and the execution of that command by the autonomous vehicle 102, then the performance optimization module 108 is configured for generating a corrective course of action for improving a lap time of the autonomous vehicle during the race event if the one or more errors are detected. The performance optimization module 108 is further configured for feeding back the additional information and the corrective course of action to the autonomous vehicle controller unit 104 if one or more errors are detected.

In accordance with an embodiment of the present subject matter, the additional information includes meaningful deductions associated with the autonomous vehicle 102, the race circuit road surface, and the environment derived from the first set of real-time parameter values, the second set of real-time parameter values, and an optimization algorithm of the performance optimization module 108. For example, a GKNSS-RTK sensor and the slip angle sensors may provide information regarding whether, at a sharp turn, the autonomous vehicle 102 has deviated from the path defined in the control command from the autonomous vehicle controller unit 104. If a deviation is detected, the performance optimization module 108 learns that the friction of the tire with the road surface at the sharp turn is not in line with the predicted path of the autonomous vehicle 102, thereby indicating that the autonomous vehicle 102 slipped outwardly from the predicted path and thus indicating that the friction between the tires and the road surface was insufficient. A meaningful deduction from such a scenario may be that the applied acceleration was more than required or that the road surface was either wet or contained excessive tire debris at the sharp turn. Therefore, as a corrective course of action, the performance optimization module 108 provides feedback to the autonomous vehicle controller unit 102 to monitor the acceleration at the sharp turn in the next lap. Alternatively, feedback is given to avoid that particular patch of road surface with excessive tire debris and thereby reduce the deviation of the autonomous vehicle 102 from the predicted path. The feedback thereby optimizes the performance of the autonomous vehicle 102 to reduce the lap time for the subsequent lap.

In another embodiment, the friction coefficient between the autonomous vehicle's tires and roads comprises a meaningful parameter. Across the autonomous vehicle's course, there is a contact coefficient that may be considered a default condition. With each lap, the parameter of friction may be increased or decreased. A racing course may be divided into different areas for purposes of parameter collection and analysis. Analysis may depend on weather. For example, both during and after a light rain some gathering of water on the racing surface is expected and this allows for setting an initial parameter. Comparing expected and actual values of a parameter, such as a contact coefficient, gives the autonomous vehicle the ability to correct performance during a race.

In a further example, the parameters reflect engine and battery use. Before the race, an optimal speed for speed at corners and turns is calculated. After the first lap or subsequent laps, collected parameter data reveal that the estimation of battery and engine is not correct. For example, the autonomous vehicle does not achieve the expected speed using the initial parameters. A decrease in the target speed for the next lap is then calculated. Actual parameters are measured on a lap-by-lap or segment-by-segment basis during the race and speed is recalculated with optimized battery and engine parameters.

In yet another example, the parameter at issue comprises g-forces during cornering or top speed. During the race, unexpected airflow, side winds, or other unknown or unpredicted factors contradict the a priori top speed calculated for a particular lap or lap segment. For example, the autonomous vehicle starts with a 100 km per hour top speed. Parameter values measured during a lap or lap segment reveal that this top speed may be increased for the next lap or lap segment based on parameter recalculations in view of measured parameters. Corrections include going to the outer radius of the circle when corning or decreasing speed.

Other parameters include tire friction and degradation. For example, before the race, tire degradation can be predicted but may change during the race. The actual degradation is measured in race and then recalculated to an optimized parameter.

In traditional racing, human drivers make decisions based on experience, perception, and arbitrary preferences. For example, certain pathing during a race may be chosen by a human driver because of past experience, comfort level, and emotional state. In autonomous racing according to the invention, actual race time parameters are measured and corrected without regard to bias and preferences inherent in human drivers. The corrections applied are more precise and justified by data. Aerodynamics and friction measurements determine how and why the top speed varies and how to make adjustments over the course of a lap or lap segment. Thus, parameters are adjusted based only on conditions that actually affect autonomous vehicle performance and by automatic correction of parameters during a race. For example, the friction coefficient for a given vehicle configuration and race path is calculated a priori to be x. This value is recalculated during the race based on measured parameters. For example, oversteering or understeering are reduced and autonomous vehicle performance improved.

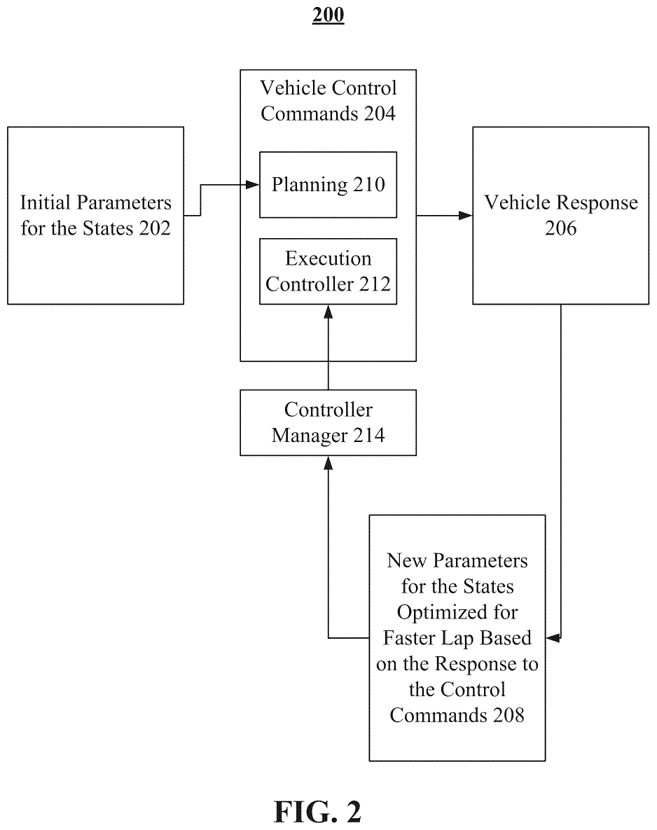

A schematic operation of system 100 is described with reference to FIG. 2. FIG. 2 illustrates a schematic block diagram depicting a general operational scheme of the system 100, in accordance with an embodiment of the present subject matter. Referring to FIG. 2, the operation scheme 200 is described. At block 202, the initial parameters are recorded and pre-fed to the autonomous vehicle controller unit 104, in accordance with one embodiment of the present subject matter. More specifically, these initial parameters are nothing but the first and second sets of initial parameter values. The first set of initial parameter values comprises the values of parameters associated with the autonomous vehicle 102, such as battery charge, motor conditioning, motor temperature, tire wear, tire temperature, tire pressure, and the like. The second set of initial parameter values comprises parameters external to the autonomous vehicle 102, such as weather conditions, race-circuit road surface information, the map of the race circuit, and so on.

At block 204, at the start of a race event, the autonomous vehicle controller unit 104 of the autonomous vehicle 102 gives control commands to the autonomous vehicle 102 based on the first and second set of initial parameter values for extracting the most optimal performance from the autonomous vehicle 102 for completing a circuit lap in a shortest possible time period.

Block 204 further includes a planning block 210, which represents the commands that execution controller 212 generates. It should be noted that execution controller 212 is one of several controllers that can be selected from by controller manager 214. Controller manager 214 assesses how the vehicle performs when executing commands generated by execution controller 212. If said performance does not meet certain criteria, controller manager 214 selects a different execution controller to perform planning 210.

At block 206, the vehicle response is recorded by means of the set of sensors 106. More specifically, the different sensors configured on the autonomous vehicle 102 allow the monitoring of various parameters such as tire wear, tire pressure, vehicle movement, vehicle acceleration or deceleration (braking), and friction of the tires with the race circuit road surface, and so on. Therefore, the set of sensors 106 facilitates monitoring of the response that the autonomous vehicle 102 provides to the control commands given by the autonomous vehicle controller unit 104. This response is recorded by the set of sensors in the form of the first set of real-time parameter values and the second set of real-time parameter values. At block 208, new parameter values, the first and second sets of real-time parameter values, are recorded for optimizing and improving the performance of the autonomous vehicle 102 to reduce the lap time during the race event. More specifically, the first and second sets of real-time parameter values are analyzed further by the performance optimization module 108, wherein the performance optimization module 108 is configured onboard the autonomous vehicle 102. This analysis is then fed back from block 208 to block 204, as seen in FIG. 2. For example, the performance optimization module 108 analyzes the first and second sets of real-time parameter values, detects if there is an error between the control command given out by the autonomous vehicle controller unit 104 and the execution of the command by the autonomous vehicle 102. The performance organization module 108 learns additional information about the autonomous vehicle 102, the race circuit road surface, and the environment while also providing a corrective course of action, which is then fed back to the autonomous vehicle controller unit 104. In an embodiment, this feedback loop continues to operate as long as the autonomous vehicle 102 is participating in the race event. Thus, the first and second sets of real-time parameter values are updated and further analyzed for continued optimization of the performance of the autonomous vehicle 102. The feedback loop from the performance optimization module 108 to the autonomous vehicle controller unit 104 is thus a process that keeps on repeating itself throughout the race event.

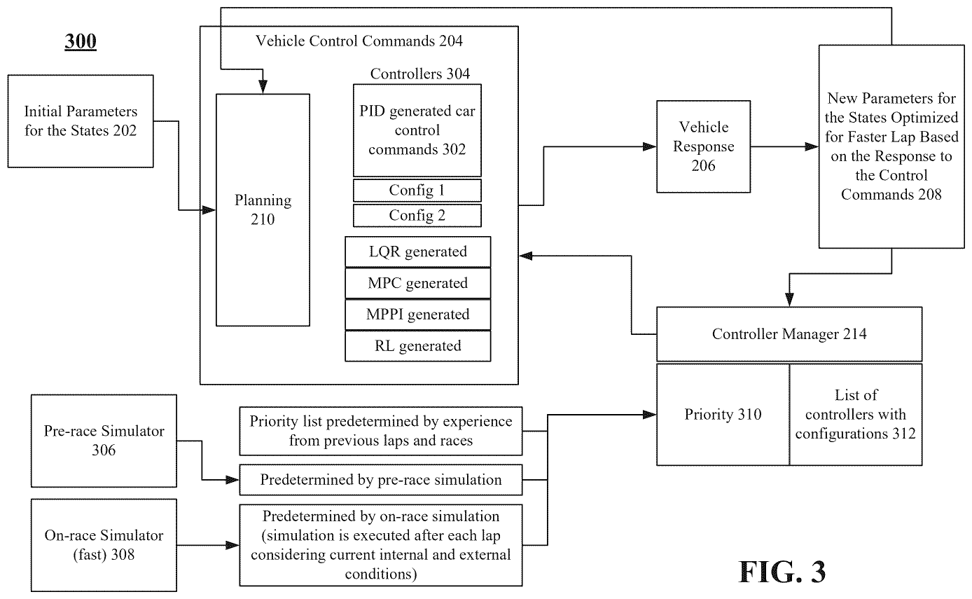

FIG. 3 illustrates a block diagram of a system 300 for optimizing the performance of an autonomous vehicle to reduce the lap times during a race event using different controllers. Compared to FIG. 2, system 300 expands on execution controller 212, revealing a plurality of controllers 304 that can be selected from to become execution controller 212. For example, execution controller 212 may be a PID controller of a particular configuration. Controllers 304 may feature several other configurations of the PID controller and other types of controllers such as an LQR controller, an MPC controller, etc. The controller that is actively controlling the autonomous vehicle, as selected by controller manager 214 is titled the execution controller 212.

FIG. 3 specifically highlights a list of controllers with configurations 312 and their associated priorities 310. A priority value is assigned to a controller using information gathered using pre-race simulator 306 and on-race simulator 308. These simulators are configured to record experience from previous simulated races and the current race (simulation is executed after each lap considering current internal and external conditions). Controller manager 214 receives this information as well as historic real-world race information to evaluate performances of the individual controllers and assign the priority value. In a technical context, the priority value assigned to each controller within system 300 is determined through a comprehensive analysis of both simulated and real-world race data. The pre-race simulator 306 and on-race simulator 308 capture detailed performance metrics under various conditions. These simulators evaluate each controller's ability to minimize lap times, maintain stability, and adapt to changing track conditions. The data collected includes parameters such as speed, acceleration, braking efficiency, and handling precision. Controller manager 214 processes this information alongside historical race data to assess the effectiveness of each controller configuration. By comparing these metrics, the system assigns a priority value that reflects the controller's potential to optimize performance in the current race environment.

Controllers within system 300 may be specialized for specific cars, tracks, or road conditions, which influences their assigned priority values. For instance, a particular controller might excel in handling high-speed circuits with long straights, while another might be optimized for tight, technical tracks with frequent turns. Additionally, certain controllers may perform better in adverse weather conditions, such as rain or snow, due to their advanced traction control algorithms. As a result, a controller can have multiple priority values, each corresponding to its strengths and weaknesses in different scenarios. This specialization allows the controller manager to dynamically select the most suitable controller based on the current race conditions, ensuring optimal performance and adaptability.

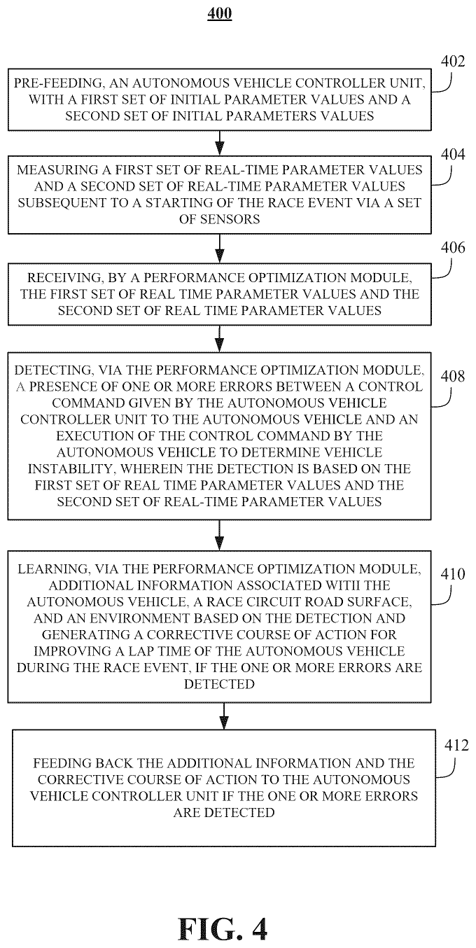

The present subject matter also envisages a method 400 for optimizing the performance of an autonomous vehicle in real-time during a race event as shown in in FIG. 4.

At block 402, method 400 includes the step of pre-feeding an autonomous vehicle controller unit 104 with the first set of initial-parameter values and the second set of initial-parameter values. In an embodiment, the first set of initial parameter values includes a plurality of parameter values associated with the autonomous vehicle before the starting of the race event, and the second set of initial parameter values includes a plurality of parameter values associated with the environment and the race circuit road surface before the starting of the race event. In an embodiment, some values from the first set of initial parameter values are provided by the manufacturers of parts, components, or assemblies used by the autonomous vehicle 102. In other embodiments, the values are derived from measurement techniques, including optimization calculations. For example, the information associated with tire wear may be provided by the tire manufacturer, whereas the information associated with the battery's state of charge (SOC) may be provided by the autonomous vehicle 102. The information associated with the second set of initial parameter values is obtained in one or more of the same ways. This information is based on the first and second set of initial parameter values that the autonomous vehicle controller unit 104 provides the control commands to the autonomous vehicle 102 at the start of the race event for extracting the most optimal performance from the autonomous vehicle 102.

At block 404, method 400 includes the step of measuring a first set of real-time parameter values and the second set of real-time parameter values subsequent to the starting of the race event via a set of sensors. In an embodiment, the first set of real-time parameter values includes a plurality of parameter values associated with the autonomous vehicle subsequent to the starting of the race event, and the second set of real-time parameter values includes a plurality of parameter values associated with the environment and the race circuit road surface subsequent to the starting of the race event. The first and second sets of real-time parameter values are recorded by the set of sensors 106 configured onboard the autonomous vehicle 102.

At block 406, method 400 comprises the step of receiving, by a performance optimization module 108, the first set of real-time parameter values and the second set of real-time parameter values. In an embodiment, the performance optimization module 108 is configured onboard the autonomous vehicle 102. Method 400 is for optimizing the performance of the autonomous vehicle 102 for reducing the lap time during the race event, and for that, the first set of real-time parameter values and the second set of real-time parameter values are constantly recorded by the set of sensors 106 and analyzed by the performance optimization module 108.

At block 408, the method 400 includes the step of detecting, via the performance optimization module 108, the presence of one or more errors between a control command given by the autonomous vehicle controller unit 104 to the autonomous vehicle 102 and the execution of the control command by the autonomous vehicle 102 to determine vehicle instability, wherein the detection is based on the first set of real-time parameter values and the second set of real-time parameter values. More specifically, in this step, the performance optimization module 108 identifies whether the autonomous vehicle 102 is performing in accordance with the control commands given by the autonomous vehicle controller unit 104. This optimization uses an analysis of the first and second real-time parameter values. More specifically, the analysis detects errors and monitors the real-time parameters that can still be used for further processing. If an error is not detected between the control command from the autonomous vehicle controller unit 104 and its execution by the autonomous vehicle 102, the information from the first and second set of real-time parameter values allows the performance optimization module 108 to learn that the current performance of the autonomous vehicle 102 does not require any further optimization. The same control commands are typically repeated for subsequent laps as well for the same sets of real-time parameter values.

At block 410, the method 400 comprises the step of learning, via the performance optimization module 108, additional information associated with the autonomous vehicle, a race circuit road surface, and an environment. Errors detected are used to generate a corrective course of action for improving a lap time of the autonomous vehicle during the race event. In this step, the performance optimization module 108 derives information from the first and second sets of real-time parameter values. For example, during the race, the tire temperature may appear to be lower than expected, while at the same time the friction between the road surface and the tires may be inadequate. Therefore, the performance optimization module 108, in accordance with one embodiment, may process these values to arrive at the conclusion that it is raining. This happens when, for example, detected error correlates with wet road conditions. In another example, at a sharp turn, the autonomous vehicle 102 slightly deviated outwardly while making the turn, whereas the tire temperature and tire wear were at expected values. In such a scenario, the performance optimization module 108 concludes that the acceleration was more than required at that particular sharp turn, and this caused the autonomous vehicle 102 to deviate from the predicted path. In this context, additional information is not the information obtained from the set of sensors 106, but it is the deductions that the performance optimization module 108 makes based on the first and second sets of real-time parameter values in conjunction with the optimization algorithm of performance optimization module 108. The additional information, in accordance with the present embodiment, includes a corrective course of action. The corrective course of action is generated by the performance optimization module 108 when an error is detected at step 408 of the method 400.

At block 412, method 400 comprises the step of feeding back the additional information and the corrective course of action to the autonomous vehicle controller unit 104 if one or more errors are detected. The step of feeding back the additional information and the corrective course of action to the autonomous vehicle controller unit 104 is to allow the autonomous vehicle controller unit 104 to provide the control commands to the autonomous vehicle 102 differently when the autonomous vehicle 102 faces the same constraints in the next lap. The step of providing the feedback is a continuous process, which causes the first and second real-time values to be constantly updated and analyzed for optimization during the course of the race event in order to minimize the time required by the autonomous vehicle for completing the next lap.

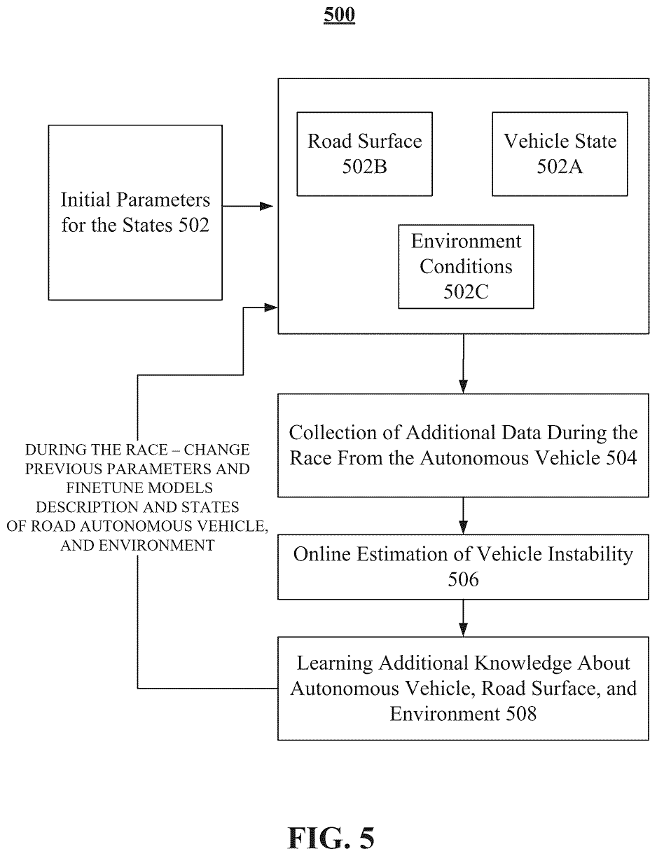

FIG. 5 illustrates a schematic block diagram 500 depicting a general operational scheme of the method 400, in accordance with an embodiment of the present subject matter. At block 502, the initial parameters, i.e., the first and second sets of initial parameter values are pre-fed to the autonomous vehicle controller unit 104. The first set of initial parameter values includes information associated with vehicle state 502A, whereas the second set of initial parameter values includes information associated with race circuit road surface 502B and environment conditions 502C. After the race event begins, the autonomous vehicle controller unit 104 gives the control commands to the autonomous vehicle 102 based on the initial parameter values 502A, 502B, and 502C. As soon as the race event begins, the autonomous vehicle 102 begins to drive autonomously.

At block 504, as the autonomous vehicle 102 starts the race, the set of sensors 106 configured on board the autonomous vehicle 102 are configured to record and collect additional data during the race in real-time, thus obtaining the first and second sets of real-time parameter values. These parameter values are updated values of the vehicle state 502A, the race circuit road surface 502B, and the environment conditions 502C after the race event has started. These parameters vary as the autonomous vehicle 102 is driving, and constant monitoring of these parameters allows for capturing and processing of data in real-time for optimization purposes.

At block 506, estimation of vehicle instability is carried out in real-time. In one embodiment, the performance optimization module 108 performs the estimation of the vehicle instability by processing the first and second real-time parameter values. This step includes performing an analysis of the first and second real-time parameter values, i.e., the updated values of different parameters associated with the vehicle state 502A, the race circuit road surface 502B, and the environment conditions 502C for determining if the autonomous vehicle 102 is performing in accordance with the control commands given out by the autonomous vehicle controller unit 104. If there are inconsistencies between the expected and actual values of the first and second set of real-time parameter values, the performance optimization module 108 detects the error and estimates the vehicle instability. If the expected and actual values of the first and second real-time parameter values are consistent, no vehicle instability is detected, and this is an indication to the autonomous vehicle controller unit 104 that no corrective action is required when the autonomous vehicle 102 faces the same constraints in the next lap.

At block 508, the performance optimization module 108 learns additional information about the autonomous vehicle 102, the race circuit road surface, and the environment. More specifically, as discussed previously, additional information is the meaningful deductions that the performance optimization module 108 arrives at based on the first and second sets of real-time parameter values and the optimization algorithm of the performance optimization module 108.

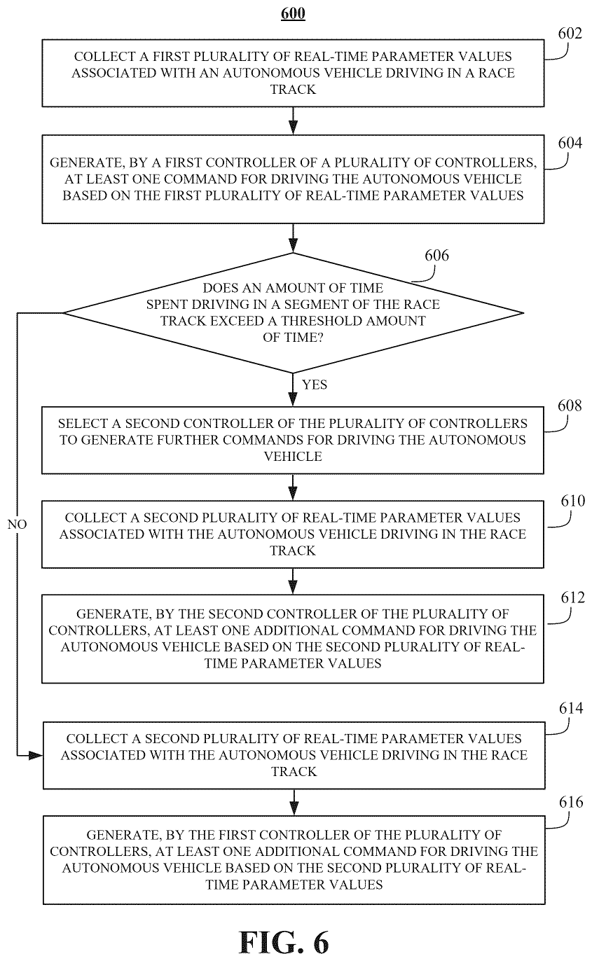

FIG. 6 illustrates a flow diagram of a method 600 for optimizing the performance of an autonomous vehicle to reduce the lap times during a race event using different controllers.

At 602, system 300 collects a first plurality of real-time parameter values associated with an autonomous vehicle driving in a race track. In the context of system 300, the first plurality of real-time parameter values includes both vehicle parameters (e.g., speed, brake status, tire information, etc.) and environment parameters (e.g., road surface, temperature, humidity, weather, etc.).

At 604, system 300 generates, by a first controller (e.g., PID controller configuration 1) of a plurality of controllers 304, at least one command for driving the autonomous vehicle based on the first plurality of real-time parameter values. For example, the PID controller configuration 1 may command the autonomous vehicle to decelerate from 70 mph to 68 mph. It should be noted that this example is highly simplistic. The at least one command may be significantly more detailed and technical (e.g., at time t1, apply brakes at 70% pressure for 2 seconds to reduce speed from 70 mph to 68 mph), and may also integrate other components of the vehicle (e.g., rotate steering wheel clockwise an additional 5 degrees for 2 seconds while decelerating).

Furthermore, the at least one command may be executed over a certain period of time and may indicate a sequence of actions that the vehicle needs to take. In a more technical example, the PID controller configuration 1 may issue a series of commands to optimize the vehicle's performance on a specific section of the race track. At time t1, the controller may instruct the autonomous vehicle to apply the brakes at 70% pressure for 2 seconds to reduce speed from 70 mph to 68 mph. Simultaneously, it may command the steering system to adjust the wheel angle by rotating it clockwise an additional 5 degrees to maintain optimal traction during deceleration. As the vehicle approaches a sharp turn at time t2, the controller may further refine the commands by reducing brake pressure to 50% while increasing throttle input to maintain momentum, ensuring the vehicle exits the turn efficiently. These commands are executed in a precise sequence, integrating real-time feedback from the vehicle's sensors to adapt to changing track conditions and enhance overall performance.

At 606, system 300 determines whether an amount of time spent driving in a segment of the race track exceeds a threshold amount of time when the autonomous vehicle executes the at least one command. In some aspects, the segment is a lap around the race track. In other aspects, the segment is any portion of a route, with the portion having a fixed distance (e.g., 1 mile).

For example, system 300 may determine whether the amount of time (e.g., 5 minute) exceeds a threshold period of time (e.g., 4 minutes 30 seconds).

In response to determining that an amount of time spent driving in a segment of the race track exceeds a threshold amount of time when the autonomous vehicle executes the at least one command, method 600 advances to 608, where system 300 selects a second controller of the plurality of controllers to generate further commands for driving the autonomous vehicle. In some aspects, the second controller is the first controller with a different set of configurations.

In some aspects, the plurality of controllers comprises any combination of: a Proportional-Integral-Derivative (PID) controller, a Linear Quadratic Regulator (LQR) controller, a Model Predictive Control (MPC) controller, a Model Predictive Path Integral (MPPI) controller, and a Reinforcement Learning (RL) controller. For example, the second controller may be the RL controller.

In some aspects, system 300 selects the second controller of the plurality of controllers by determining a priority value of the second controller. In some aspects, system 300 determines the priority value based on at least one of: previous drives performed on the race track (e.g., the second controller may have generated on-average faster segment times than the first controller in previous real-world drives), drives performed in at least one simulation on a virtual representation of the race track (e.g., the second controller may have generated on-average faster segment times than the first controller in previous simulated drives), a current drive of the autonomous vehicle on a previous segment of the race track (e.g., the second controller may have generated on-average faster segment time than the first controller in the same drive session). In general, a higher priority value is assigned to a given controller of the plurality of controllers in response to determining that the given controller generates commands causing a lowest amount of time spent driving in a segment of the race track.

In some aspects, each controller may have certain strengths and weaknesses as determined during the analysis of real-world races and simulated races. Accordingly, priority values may change based on the type of vehicle, current vehicle status, type of race track, conditions on the race track, etc. For example, the second controller may historically perform better than the first controller (i.e., yielding the lowest amount of time spent driving in a segment of the race track) when the autonomous vehicle is driving in the rain. However, the first controller may perform better than the second controller when the autonomous vehicle is driving uphill. These various conditions are captured by the acquired parameter values and may be input into a machine learning algorithm that ranks each of the controllers by assigning multiple priority values. The controller of the highest rank is selected by the controller manager to control the movement of the autonomous vehicle.

In a practical example, system 300 may analyze the performance of various controllers under different environmental conditions to optimize the autonomous vehicle's lap times. Suppose the race track is experiencing heavy rain, which affects traction and visibility. The system may determine that the Reinforcement Learning (RL) controller has historically performed better in wet conditions, achieving faster segment times due to its adaptive learning capabilities. Consequently, the RL controller is assigned a higher priority value for this scenario. Conversely, if the race track includes a steep uphill section, the Model Predictive Control (MPC) controller may be favoured due to its ability to efficiently manage power distribution and maintain speed during elevation changes. By leveraging machine learning algorithms, system 300 continuously evaluates and ranks the controllers based on real-time data and historical performance, ensuring the most suitable controller is selected to navigate the current track conditions effectively. This dynamic selection process enhances the autonomous vehicle's overall performance by adapting to varying track challenges.

In general, system 300 determines at least one other priority value of other controllers in the plurality of controllers. In response to determining that the priority value exceeds the at least one other priority value, system 300 selects the second controller.

At 610, system 300 collects a second plurality of real-time parameter values associated with the autonomous vehicle driving in the race track. For example, after selecting the second controller, additional parameter values may be collected for a different segment. These parameter values may be new road conditions, weather updates, etc.

At 612, system 300 generates, by the second controller of the plurality of controllers, at least one additional command for driving the autonomous vehicle based on the second plurality of real-time parameter values. In other words, the second controller takes control of driving decisions.

At 606, in response to determining that the amount of time spent driving in the segment of the race track does not exceed the threshold amount of time when the autonomous vehicle executes the at least one command, method 600 advances to 614, where system 300 collects a second plurality of real-time parameter values associated with the autonomous vehicle driving in the race track.

At 616, system 300 generates, by the first controller of the plurality of controllers, at least one additional command for driving the autonomous vehicle based on the second plurality of real-time parameter values. In other words, because there is no issue with the decision making of the first controller, system 300 continues to rely on the first controller for decision making.

Thus far the second controller is selected based on a time to traverse a segment. However, the second controller may be selected for other reasons as well. For example, system 300 may identify instability of the autonomous vehicle in response to detecting one or more discrepancies between the at least one command generated by the first controller and an execution of the at least one command by the autonomous vehicle. System 300 may generate, by the first controller, a corrective action for resolving the instability. In response to determining that the corrective action does not resolve the instability, system 300 selects the second controller of the plurality of controllers to generate further corrective actions for driving the autonomous vehicle.

In an example of instability, suppose the first controller commands the autonomous vehicle to maintain a steady speed of 60 mph while navigating a series of sharp turns. However, due to unexpected road conditions such as loose gravel or oil on the track, the vehicle begins to skid, deviating from the intended path. This discrepancy between the commanded trajectory and the actual execution indicates instability, as the vehicle's sensors detect a loss of traction and control.

To address this instability, system 300 may generate a corrective action through the first controller. For instance, the controller may adjust the vehicle's speed by reducing throttle input and applying gentle braking to regain traction. Additionally, it may modify the steering angle to counteract the skid and realign the vehicle with the desired path. These corrective actions are determined by analyzing real-time sensor data and applying control algorithms designed to stabilize the vehicle under adverse conditions.

If the corrective action fails to resolve the instability, such as if the vehicle continues to skid or veer off course, system 300 may switch to the second controller. The second controller, perhaps a Model Predictive Control (MPC) or Reinforcement Learning (RL) controller, may offer more advanced adaptive strategies to handle the instability. It may employ predictive models to anticipate future vehicle behavior and adjust commands accordingly, ensuring the vehicle regains stability and continues safely along the race track.

In some aspects, after each segment, the controller manager may assess whether to continue utilizing the first controller or switch to a different controller. As mentioned previously, each controller may excel in a specific set of conditions. As each segment may present new conditions, the controller manager may detect that the conditions have changed, anticipate that the conditions will continue throughout the upcoming segment and chose a controller that excels in said conditions accordingly.

In a practical scenario, consider an autonomous vehicle navigating a race track with varying weather conditions. During the initial segment, the track is dry, and the first controller, a Proportional-Integral-Derivative (PID) controller, is used due to its precise control in stable conditions. However, as the vehicle progresses to the next segment, the weather changes, and a light rain begins to fall, making the track slippery. The controller manager detects this change in conditions through real-time sensor data indicating increased humidity and reduced traction.

Anticipating that the rain will persist throughout the upcoming segment, the controller manager decides to switch to a Model Predictive Control (MPC) controller, which may be known for its ability to handle dynamic and uncertain environments effectively (based on historic drives or simulations). The MPC controller may predict future states of the vehicle and adjust its commands to maintain optimal performance despite the wet conditions. By selecting the most suitable controller for the current and anticipated conditions, the controller manager ensures that the autonomous vehicle maintains its performance and safety on the track.

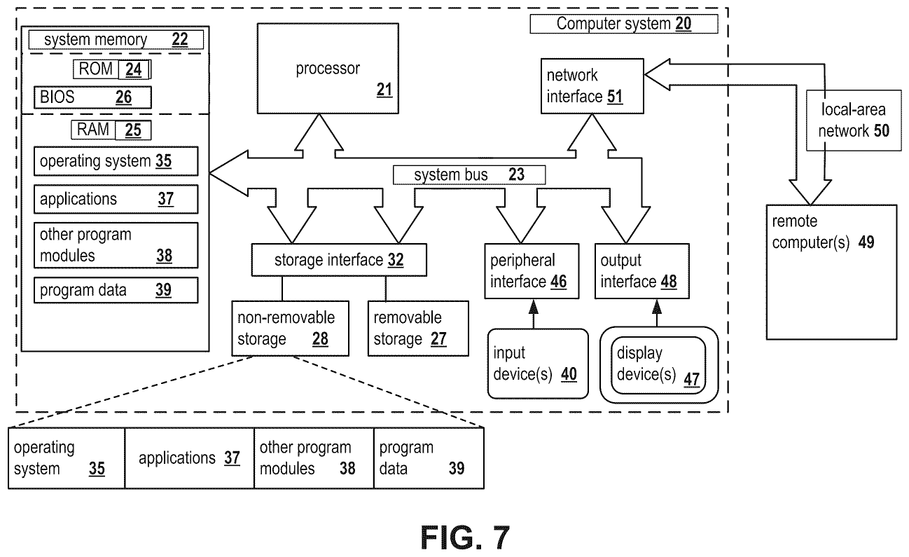

FIG. 7 is a block diagram illustrating a computer system 20 on which aspects of systems and methods for optimizing the performance of an autonomous vehicle to reduce the lap times during a race event using different controllers may be implemented in accordance with an exemplary aspect. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices. For example, the computer system 20 may be an on-board computing device installed in the autonomous vehicle.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-6 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort may be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for optimizing a performance of an autonomous vehicle in real-time, the method comprising:
collecting a first plurality of real-time parameter values associated with an autonomous vehicle driving in a race track;
generating, by a first controller of a plurality of controllers, at least one command for driving the autonomous vehicle based on the first plurality of real-time parameter values; in response to determining that an amount of time spent driving in a segment of the race track exceeds a threshold amount of time when the autonomous vehicle executes the at least one command, selecting a second controller of the plurality of controllers to generate further commands for driving the autonomous vehicle, wherein selecting the second controller comprises:
determining priority values of the plurality of controllers, wherein the priority values change based on one or more of a type of vehicle, current vehicle status, type of race track, and conditions on the race track;
inputting conditions captured by the first plurality of real-time parameter values into a machine learning algorithm that ranks each of the controllers by assigning multiple priority values; and
selecting, by a controller manager, a controller of a highest rank as the second controller to control movement of the autonomous vehicle;
collecting a second plurality of real-time parameter values associated with the autonomous vehicle driving in the race track; and
generating, by the second controller of the plurality of controllers, at least one additional command for driving the autonomous vehicle based on the second plurality of real-time parameter values.

2. The method of claim 1, wherein the second controller is the same as the first controller but with different settings.

3. The method of claim 1, wherein the plurality of controllers comprises any combination of: a Proportional-Integral-Derivative (PID) controller, a Linear Quadratic Regulator (LQR) controller, a Model Predictive Control (MPC) controller, a Model Predictive Path Integral (MPPI) controller, and a Reinforcement Learning (RL) controller.

4. The method of claim 1, wherein selecting the second controller is performed by a controller manager that accesses a list indicative of the plurality of controllers and various configurations of each of the plurality of controllers.

5. The method of claim 1, wherein selecting the second controller of the plurality of controllers comprises:
determining a priority value of the second controller;
determining at least one other priority value of other controllers in the plurality of controllers;
in response to determining that the priority value exceeds the at least one other priority value, selecting the second controller.

6. The method of claim 5, wherein the priority value is determined based on at least one of: previous drives performed on the race track, drives performed in at least one simulation on a virtual representation of the race track, a current drive of the autonomous vehicle on a previous segment of the race track.

7. The method of claim 6, wherein a higher priority value is assigned to a given controller of the plurality of controllers in response to determining that the given controller generates commands causing a lowest amount of time spent driving in a segment of the race track.

8. The method of claim 1, further comprising:
identifying instability of the autonomous vehicle in response to detecting one or more discrepancies between the at least one command generated by the first controller and an execution of the at least one command by the autonomous vehicle;
generating, by the first controller, a corrective action for resolving the instability;
in response to determining that the corrective action does not resolve the instability, selecting the second controller of the plurality of controllers to generate further corrective actions for driving the autonomous vehicle.

9. The method of claim 1, wherein the segment is a lap around the race track.

10. A system for optimizing a performance of an autonomous vehicle in real-time, comprising:
at least one memory; and
at least one hardware processor coupled with the at least one memory and configured, individually or in combination, to:
collect a first plurality of real-time parameter values associated with an autonomous vehicle driving in a race track;
generate, by a first controller of a plurality of controllers, at least one command for driving the autonomous vehicle based on the first plurality of real-time parameter values; in response to determining that an amount of time spent driving in a segment of the race track exceeds a threshold amount of time when the autonomous vehicle executes the at least one command, select a second controller of the plurality of controllers to generate further commands for driving the autonomous vehicle, wherein the at least one hardware processor is configured to select the second controller by:
determining priority values of the plurality of controllers, wherein the priority values change based on one or more of a type of vehicle, current vehicle status, type of race track, and conditions on the race track;
inputting conditions captured by the first plurality of real-time parameter values into a machine learning algorithm that ranks each of the controllers by assigning multiple priority values; and
selecting, by a controller manager, a controller of a highest rank as the second controller to control movement of the autonomous vehicle;
collect a second plurality of real-time parameter values associated with the autonomous vehicle driving in the race track; and
generate, by the second controller of the plurality of controllers, at least one additional command for driving the autonomous vehicle based on the second plurality of real-time parameter values.

11. The system of claim 10, wherein the second controller is the same as the first controller but with different settings.

12. The system of claim 10, wherein the plurality of controllers comprises any combination of: a Proportional-Integral-Derivative (PID) controller, a Linear Quadratic Regulator (LQR) controller, a Model Predictive Control (MPC) controller, a Model Predictive Path Integral (MPPI) controller, and a Reinforcement Learning (RL) controller.

13. The system of claim 10, wherein selecting the second controller is performed by a controller manager that accesses a list indicative of the plurality of controllers and various configurations of each of the plurality of controllers.

14. The system of claim 10, wherein the at least one hardware processor is further configured to select the second controller of the plurality of controllers by:
determining a priority value of the second controller;
determining at least one other priority value of other controllers in the plurality of controllers;
in response to determining that the priority value exceeds the at least one other priority value, selecting the second controller.

15. The system of claim 14, wherein the priority value is determined based on at least one of: previous drives performed on the race track, drives performed in at least one simulation on a virtual representation of the race track, a current drive of the autonomous vehicle on a previous segment of the race track.

16. The system of claim 15, wherein a higher priority value is assigned to a given controller of the plurality of controllers in response to determining that the given controller generates commands causing a lowest amount of time spent driving in a segment of the race track.

17. The system of claim 10, wherein the at least one hardware processor is further configured to:
identify instability of the autonomous vehicle in response to detecting one or more discrepancies between the at least one command generated by the first controller and an execution of the at least one command by the autonomous vehicle;
generate, by the first controller, a corrective action for resolving the instability;
in response to determining that the corrective action does not resolve the instability, select the second controller of the plurality of controllers to generate further corrective actions for driving the autonomous vehicle.

18. The system of claim 10, wherein the segment is a lap around the race track.

19. A non-transitory computer readable medium storing thereon computer executable instructions for optimizing a performance of an autonomous vehicle in real-time, including instructions for:
collecting a first plurality of real-time parameter values associated with an autonomous vehicle driving in a race track;
generating, by a first controller of a plurality of controllers, at least one command for driving the autonomous vehicle based on the first plurality of real-time parameter values;
in response to determining that an amount of time spent driving in a segment of the race track exceeds a threshold amount of time when the autonomous vehicle executes the at least one command, selecting a second controller of the plurality of controllers to generate further commands for driving the autonomous vehicle, wherein selecting the second controller comprises:
determining priority values of the plurality of controllers, wherein the priority values change based on a type of vehicle, current vehicle status, type of race track, and conditions on the race track;
inputting conditions captured by the first plurality of real-time parameter values into a machine learning algorithm that ranks each of the controllers by assigning multiple priority values; and
selecting, by a controller manager, a controller of a highest rank as the second controller to control movement of the autonomous vehicle;
collecting a second plurality of real-time parameter values associated with the autonomous vehicle driving in the race track; and
generating, by the second controller of the plurality of controllers, at least one additional command for driving the autonomous vehicle based on the second plurality of real-time parameter values.
